(19) United States
(12) Patent Application Publication
(10) Pub. No.: US 2026/0183986 A1
(43) Pub. Date: Jul. 2, 2026

(54) MAINTAINING WORKABILITY OF A CERAMIC MATRIX COMPOSITE MATERIAL IN A FORMING AREA

(71) Applicant: The Boeing Company, Arlington, VA (US)

(72) Inventors: Erik Nicholas Wienhold, Seattle, WA (US); Brian James Smith, Seattle, WA (US); Sandra Louise Zmeu, Shoreline, WA (US); Christopher Robert Brown, Seattle, WA (US); Ricardo Andreas Fritzke, Sammamish, WA (US); Sangvavann Heng, Buena Park, CA (US); Merna Essam Salama, Cerritos, CA (US); Brice Aaron Johnson, Toledo, WA (US); Lisa C. Zgherea, Tukwila, WA (US)

(21) Appl. No.: 19/005,212

(22) Filed: Dec. 30, 2024

(51) Int. Cl. B28B 17/00; C04B 38/00

(52) U.S. Cl. CPC B28B 17/0081; C04B 38/00; C04B 2235/65; C04B 2290/00

(57) ABSTRACT

A forming area for automated composite processing and methods of maintaining workability of a ceramic matrix composite material in a forming area are presented. It is determined if a humidity within the forming area is in a desired range. In response to a determination that the humidity is not in the desired range, at least one of a heater or a humidifier is activated by an environmental controller to maintain a desired humidity for forming the ceramic matrix composite material within the forming area.

### STATEMENT OF GOVERNMENT INTEREST

This invention was made with Government support under contract number AFRL ManTech FA2394-23-C-B006 awarded by Department of Defense. The government has certain rights in this invention.

### BACKGROUND INFORMATION

### 1. Field

The present disclosure relates generally to composite manufacturing and more specifically to maintaining workability of composite materials.

### 2. Background

It is desirable to automate as many composite manufacturing steps as possible. Currently, peeling protective films from composite materials and placing the composite materials present challenges for automation.

Therefore, it would be desirable to have a method and apparatus that takes into account at least some of the issues discussed above, as well as other possible issues. For example, it would be desirable to improve automated composite placement.

### SUMMARY

An embodiment of the present disclosure provides a forming area for automated composite processing. The forming area for automated composite processing comprises physical boundaries defining and enclosing the forming area, the physical boundaries configured to substantially reduce transmission of a temperature and a humidity from the forming area; a humidity sensor configured to detect the humidity in the forming area; a thermostat configured to detect the temperature in the forming area; and an environmental controller configured to perform at least one of activating or deactivating a heater or a humidifier based on data received from the humidity sensor and the thermostat.

Another embodiment of the present disclosure provides a method of maintaining workability of a ceramic matrix composite material in a forming area. It is determined if a humidity within the forming area is in a desired range. In response to a determination that the humidity is not in the desired range, at least one of a heater or a humidifier is activated by an environmental controller to maintain a desired humidity for forming the ceramic matrix composite material within the forming area.

Yet another embodiment of the present disclosure provides a method of maintaining workability of a ceramic matrix composite material in a forming area. An exposure time of a ceramic matrix composite material in the forming area is determined. A humidity in the forming area is modified based on the exposure time of the ceramic matrix composite material.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a forming area in accordance with an illustrative embodiment;

FIG. 4 is a flowchart of a method of maintaining workability of a ceramic matrix composite material in a forming area in accordance with an illustrative embodiment;

FIG. 5 is a flowchart of a method of maintaining workability of a ceramic matrix composite material in a forming area in accordance with an illustrative embodiment;

FIG. 6 is an illustration of an aircraft manufacturing and service method in a form of a block diagram in accordance with an illustrative embodiment; and

FIG. 7 is an illustration of an aircraft in a form of a block diagram in which an illustrative embodiment may be implemented.

### DETAILED DESCRIPTION

The illustrative examples recognize and take into account several considerations. For example, the illustrative examples recognize that composite material is held in a freezer until it is to be processed. The illustrative examples recognize and take into account that the composite material is removed from the freezer and allowed to thaw to decrease matrix viscosity prior to forming the composite material. The illustrative examples recognize and take into account that water-based Ceramic Matrix Composite material is extremely sensitive to humidity, temperature, and time of exposure to the environment (out of freezer).

The illustrative examples recognize and take into account that it can become difficult to form and work the CMC composite when it dries out and is not maintained at a desired humidity and temperature range. The illustrative examples provide monitoring and adjusting the humidity and temperature to improve reliability of automated film peeling and formability of material. In some illustrative examples, a working temperature is about 70 degrees Fahrenheit and 60-65% humidity.

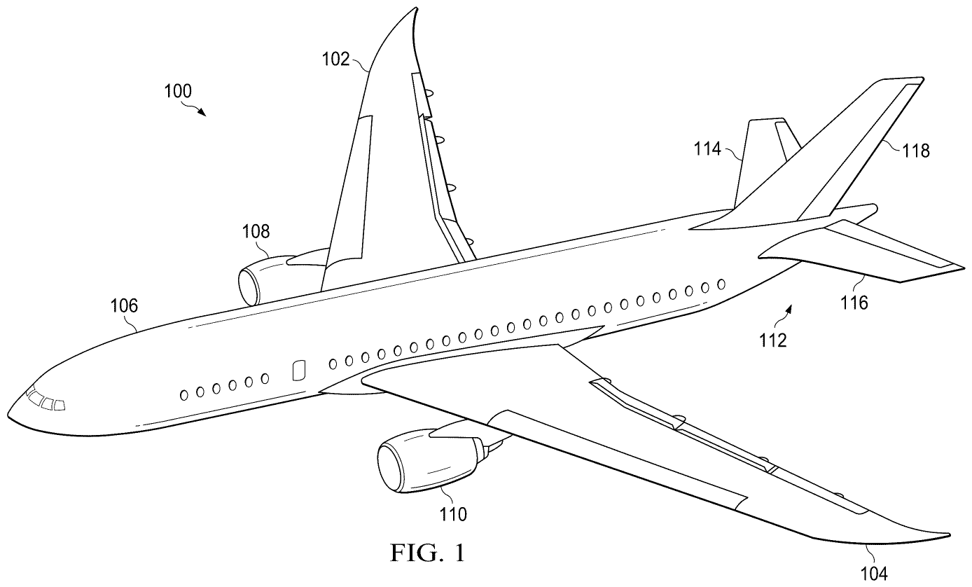

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have components formed using the illustrative examples. A portion of at least one of wing 102, wing 104, or body 106 can be formed by maintaining workability according to the illustrative examples.

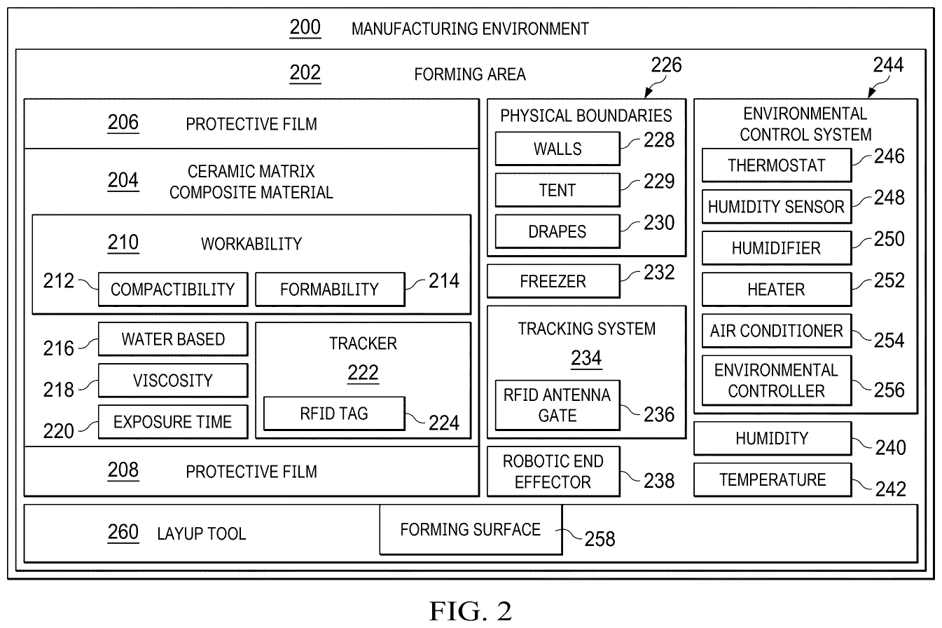

Turning now to FIG. 2, an illustration of a block diagram of a manufacturing environment is depicted in accordance with an illustrative embodiment. Manufacturing environment 200 comprises forming area 202 for automated composite processing. Composite components of aircraft 100 can be formed in forming area 202 of FIG. 2.

Forming area 202 comprises physical boundaries 226 defining and enclosing forming area 202, humidity sensor 248 configured to detect humidity 240 in forming area 202, thermostat 246 configured to detect temperature 242 in forming area 202, and environmental controller 256 configured to perform at least one of activating or deactivating heater 252 or humidifier 250 based on data received from humidity sensor 248 and thermostat 246. Physical boundaries 226 are configured to substantially reduce transmission of temperature 242 and humidity 240 from forming area 202. Ceramic matrix composite material 204 will be peeled, placed, and formed within forming area 202 by robotic end effector 238.

Physical boundaries 226 can take any desirable form. In some illustrative examples, physical boundaries 226 are present to restrict entry into forming area 202. In some illustrative examples, physical boundaries 226 are present to indicate an automated processing area. In some illustrative examples physical boundaries 226 are present to maintain humidity 240 and temperature 242 separately from the environment of manufacturing environment 200. Physical boundaries 226 can be selected from at least one of walls 228, tent 229, or drapes 230. Physical boundaries 226 are configured to substantially reduce transmission of temperature 242 and humidity 240 from forming area 202.

The outer containment provided by physical boundaries 226 permits control of the pick and place and forming CMC operations. In some illustrative examples, physical boundaries 226 are insulated. In other illustrative examples, physical boundaries 226 are not insulated. In some illustrative examples, human operators are present in forming area 202. In other illustrative examples, human operators are not present in forming area 202.

Ceramic matrix composite material 204 is water based 216. Water based 216 ceramic matrix composite material 204 is sensitive to humidity 240, temperature 242, and exposure time 220 to forming area 202 out of freezer 232. Environmental control system 244 is used to control at least one of temperature 242 or humidity 240 for workability 210 of ceramic matrix composite material 204.

Ceramic matrix composite material 204 has protective film 206 on a first side and protective film 208 on an opposite side. In some illustrative examples, the sides may be referred to as a front side and a backside. In some illustrative examples, protective film 206 and protective film 208 are referred to as a front side protective film and a back side protective film.

Workability 210 of ceramic matrix composite material 204 is influenced by humidity 240 and temperature 242 of forming area 202. Workability 210 comprises compactibility 212 and formability 214. Workability 210 is influenced by viscosity 218 of ceramic matrix composite material 204.

Freezer 232 is configured to store ceramic matrix composite material 204 in forming area 202. Ceramic matrix composite material 204 is removed from freezer 232 and allowed to thaw to decrease viscosity 218 of the matrix in ceramic matrix composite material 204. After being removed from freezer 232, at least one of protective film 206 or protective film 208 is removed from ceramic matrix composite material 204. Afterwards, ceramic matrix composite material 204 is placed onto forming surface 258 on layup tool 260.

Environmental control system 244 controls at least one of humidity 240 and temperature 242 within forming area 202 for a peeling operation and a pick and place and forming operation. Environmental control system 244 is an environmentally controlled automation cell within the humidity and temperature containing environment cell, forming area 202, within manufacturing environment 200. At least one of temperature 242 or humidity 240 are controlled within humidity and temperature containing physical boundaries 226. Air or other desirable gases can be present within the enclosure formed by physical boundaries 226.

By monitoring and adjusting humidity 240 and temperature 242, reliability of automated film peeling and formability of ceramic matrix composite material 204 is improved. In some illustrative examples, working temperature is approximately 70 degrees Fahrenheit and approximately 65% humidity. It is difficult to form and work ceramic matrix composite material 204 when it dries out and is not maintained at approximately 60% humidity and the desired temperature range. Temperature 242 and humidity 240 is monitored by environmental control system 244, and work is only performed when values of temperature 242 and humidity 240 are within predetermined range.

In some illustrative examples, a type of ceramic matrix composite material 204 is used to determine the predetermined ranges for temperature 242 and humidity 240. In some illustrative examples, environmental control system 244 maintains temperature 242 and humidity 240 within predetermined range for the type of ceramic matrix composite material 204.

In some other illustrative examples, environmental control system 244 maintains temperature 242 and humidity 240 based on type of ceramic matrix composite material 204 as well as exposure time 220. Exposure time 220 is determined based on when ceramic matrix composite material 204 is removed from freezer 232.

Tracking system 234 can be used to determine exposure time 220. Tracking system 234 can use RFID monitors or other desirable means on ceramic matrix composite material 204 to track how long ceramic matrix composite material 204 is out of freezer 232. Environmental control system 244 can be used to monitor the environment ceramic matrix composite material 204 is exposed to while out of freezer 232.

The illustrative examples can track and trace to monitor how long ceramic matrix composite material 204 is out of freezer 232. In some illustrative examples, tracking system 234 is an RFID based tracking system. Environmental control system 244 can adjust at least one of temperature 242 or humidity 240 to improve at least one of compaction of ceramic matrix composite material 204 on forming surface 258 or peeling and removal of protective film 206 and protective film 208. In these illustrative examples, at least one of humidity 240 or temperature 242 is controlled to improve viscosity 218 of the matrix dependent on the amount of time ceramic matrix composite material 204 is out of freezer 232. Compaction and peeling of protective films, protective film 206 and protective film 208, can be improved by customizing temperature 242 and humidity 240 based on exposure time 220.

Tracker 222 is associated with ceramic matrix composite material 204 to track ceramic matrix composite material 204 within forming area 202. In some illustrative examples, tracker 222 takes the form of RFID tag 224. When multiple ceramic matrix composite materials are present in forming area 202, a unique RFID tag can be associated with each material kit.

In this illustrative example, RFID antenna gate 236 monitors ceramic matrix composite material 204 as it is removed/placed in freezer 232. Time in/out of freezer 232 for ceramic matrix composite material 204 is recorded in a database. When more than one ceramic matrix composite material 204 is present in forming area 202, the time in/out of freezer 232 is recorded for each material kit.

Tracking system 234 is configured to document a time a composite material is exposed to humidity 240 and temperature 242 in forming area 202. For example, tracking system 234 can document a time ceramic matrix composite material 204 is exposed to humidity 240 and temperature 242 in forming area 202. In some illustrative examples, more than one ceramic matrix composite material is present in forming area 202. In these illustrative examples, each ceramic matrix composite material can be tracked separately within forming area 202. In some illustrative examples, a ceramic matrix composite material out of freezer 232 longest takes priority for environmental control system 244. In other illustrative examples, a ceramic matrix composite material about to be placed on forming surface 258 takes priority for environmental control system 244.

Tracker 222 is attached to ceramic matrix composite material 204 for tracking ceramic matrix composite material 204 in forming area 202. Tracker 222 can be used to determine exposure time 220 of ceramic matrix composite material 204. As depicted, tracking system 234 in forming area 202 comprises RFID antenna gate 236 and RFID tag 224.

Robotic end effector 238 in forming area 202 is configured to pick and place ceramic matrix composite material 204 in forming area 202. In some illustrative examples, robotic end effector 238 is configured to remove at least one of protective film 206 or protective film 208. Robotic end effector 238 can place ceramic matrix composite material 204 onto forming surface 258 of layup tool 260.

In some illustrative examples, forming area 202 further comprises air conditioner 254. Air conditioner 254 can be used to control both temperature 242 and humidity 240.

Robotic end effector 238 can be used to form ceramic matrix composite material 204 against forming surface 258 of layup tool 260. By robotic end effector 238 peeling and forming ceramic matrix composite material 204 against layup tool 260, operations are automated within forming area 202.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, more than one robotic end effector can be present in forming area 202. In some illustrative examples, separate robotic end effectors perform independent manufacturing steps. In some illustrative examples, separate robotic end effectors are used to peel protective films and form ceramic matrix composite material 204 against forming surface 258.

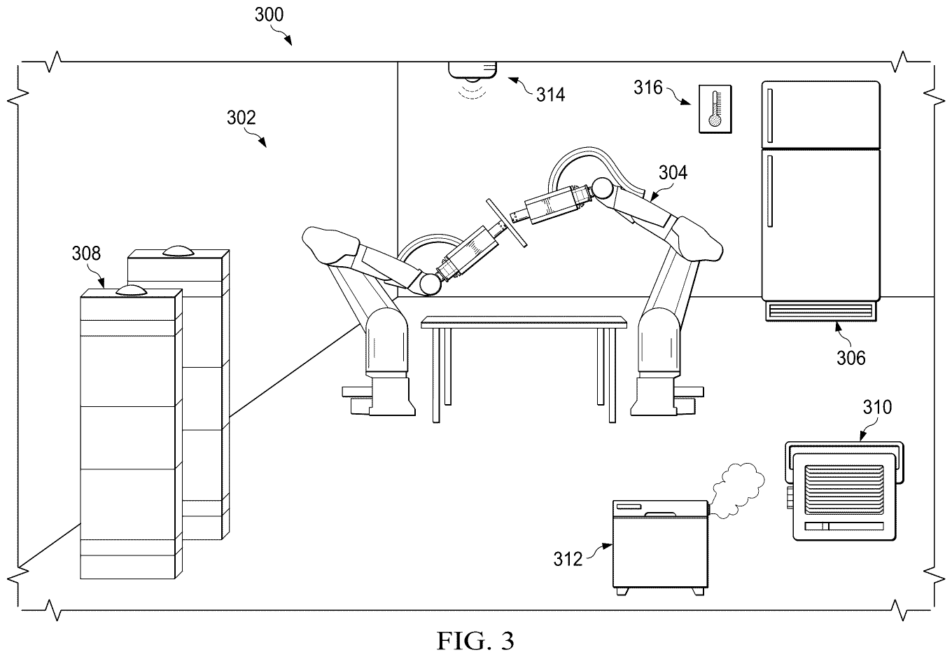

Turning now to FIG. 3, an illustration of a forming area is depicted in accordance with an illustrative embodiment. Forming area 300 is a physical implementation of forming area 202 of FIG. 2. Forming area 300 comprises physical boundaries 302. In this illustrative example, physical boundaries 302 comprise a tent configured to contain robotic end effectors 304. Robotic end effectors 304 are configured to form composite material against a layup tool. In some illustrative examples, the composite material is stored in freezer 306. After removal from freezer 306, the composite material is passed through RFID antenna gate 308 to monitor the time out of the composite material.

Forming area 300 comprises physical boundaries 302 defining and enclosing forming area 300, humidity sensor 314 configured to detect humidity in forming area 300, thermostat 316 configured to detect temperature in forming area 300, heater 310, humidifier 312, and an environmental controller (not depicted) configured to perform at least one of activating or deactivating heater 310 or humidifier 312 based on data received from humidity sensor 314 and thermostat 316. A ceramic matrix composite material can be peeled and formed within forming area 300 by robotic end effectors 304.

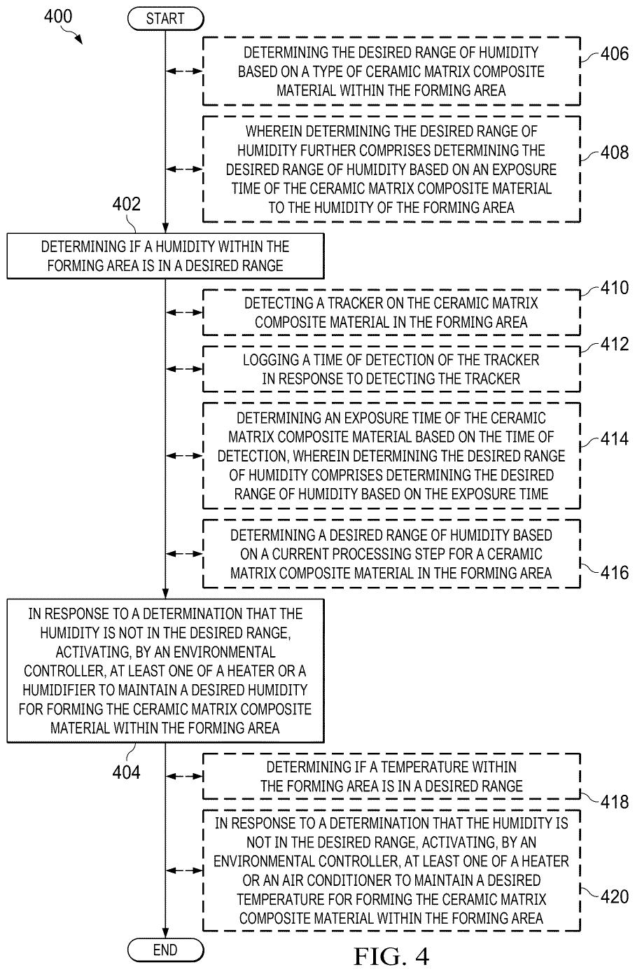

Turning now to FIG. 4, a flowchart of a method of maintaining workability of a ceramic matrix composite material in a forming area is depicted in accordance with an illustrative embodiment. Method 400 can be used to maintain workability of a ceramic matrix composite material for forming a component of aircraft 100 of FIG. 1. Method 400 can be implemented within forming area 202 of FIG. 2. Method 400 can be implemented within forming area 300 of FIG. 3.

Method 400 determines if a humidity within the forming area is in a desired range (operation 402). Method 400, in response to a determination that the humidity is not in the desired range, activates, by an environmental controller, at least one of a heater or a humidifier to maintain a desired humidity for forming the ceramic matrix composite material within the forming area (operation 404). Afterwards, method 400 terminates.

In some illustrative examples, method 400 determines the desired range of humidity based on a type of ceramic matrix composite material within the forming area (operation 406). In some illustrative examples, the desired range of humidity is affected by a type of matrix.

In some illustrative examples, determining the desired range of humidity further comprises determining the desired range of humidity based on an exposure time of the ceramic matrix composite material to the humidity of the forming area (operation 408). In some illustrative examples, the desired range of humidity is determined based on an exposure time of the ceramic matrix composite material to be formed next. In some illustrative examples, the desired range of humidity is determined based on an exposure time of the ceramic matrix composite material within the forming area that has been outside of the freezer the longest.

In some illustrative examples, method 400 detects a tracker on the ceramic matrix composite material in the forming area (operation 410). In some illustrative examples, the tracker is an RFID tracker. In other illustrative examples, the tracker can be an optical tracker.

In some illustrative examples, method 400 logs a time of detection of the tracker in response to detecting the tracker (operation 412). In some illustrative examples, method 400 determines an exposure time of the ceramic matrix composite material based on the time of detection, wherein determining the desired range of humidity comprises determining the desired range of humidity based on the exposure time (operation 414).

In some illustrative examples, method 400 determines a desired range of humidity based on a current processing step for a ceramic matrix composite material in the forming area (operation 416). In some illustrative examples, the desired range of humidity is determined for peeling a protective film from the ceramic matrix composite material in the forming area. In some illustrative examples, the desired range of humidity is determined for forming the ceramic matrix composite material in the forming area. In some illustrative examples, the desired range of humidity is determined for picking and placing the ceramic matrix composite material in the forming area. In some illustrative examples, multiple composite material sheets are present in the forming area and forming is prioritized in determining the desired range of humidity in the forming area.

In some illustrative examples, method 400 determines if a temperature within the forming area is in a desired range (operation 418). In some illustrative examples, method 400, in response to a determination that the humidity is not in the desired range, activates, by an environmental controller, at least one of a heater or an air conditioner to maintain a desired temperature for forming the ceramic matrix composite material within the forming area (operation 420).

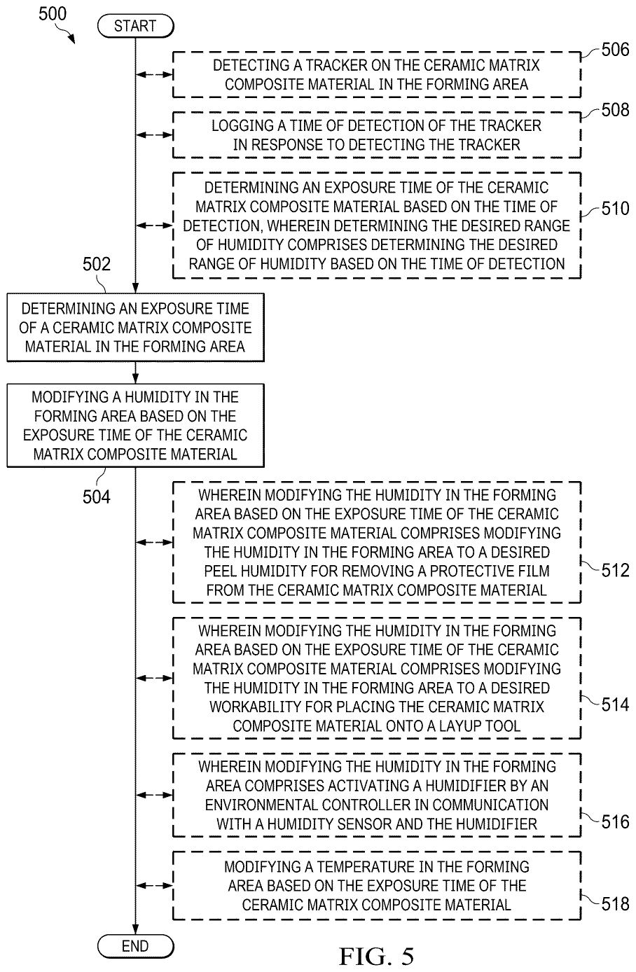

Turning now to FIG. 5, a flowchart of a method of maintaining workability of a ceramic matrix composite material in a forming area is depicted in accordance with an illustrative embodiment. Method 500 can be used to maintain workability of a ceramic matrix composite material for forming a component of aircraft 100 of FIG. 1. Method 500 can be implemented within forming area 202 of FIG. 2. Method 500 can be implemented within forming area 300 of FIG. 3.

Method 500 determines an exposure time of a ceramic matrix composite material in the forming area (operation 502). Method 500 modifies a humidity in the forming area based on the exposure time of the ceramic matrix composite material (operation 504). Afterwards, method 500 terminates.

In some illustrative examples, method 500 detects a tracker on the ceramic matrix composite material in the forming area (operation 506).

In some illustrative examples, method 500 logs a time of detection of the tracker in response to detecting the tracker (operation 508). In some illustrative examples, method 500 determines an exposure time of the ceramic matrix composite material based on the time of detection, wherein determining the desired range of humidity comprises determining the desired range of humidity based on the time of detection (operation 510).

In some illustrative examples, modifying the humidity in the forming area based on the exposure time of the ceramic matrix composite material comprises modifying the humidity in the forming area to a desired peel humidity for removing a protective film from the ceramic matrix composite material (operation 512). In some illustrative examples, modifying the humidity in the forming area based on the exposure time of the ceramic matrix composite material comprises modifying the humidity in the forming area to a desired workability for placing the ceramic matrix composite material onto a layup tool (operation 514).

In some illustrative examples, modifying the humidity in the forming area comprises activating a humidifier by an environmental controller in communication with a humidity sensor and the humidifier (operation 516). In some illustrative examples, modifying the humidity in the forming area comprises activating a dehumidifier by an environmental controller in communication with a humidity sensor and the dehumidifier.

In some illustrative examples, method 500 modifies a temperature in the forming area based on the exposure time of the ceramic matrix composite material (operation 518). In some illustrative examples, the temperature is modified by activating or deactivating a heater. In some illustrative examples, the temperature is modified by activating or deactivating an air conditioner.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, any of operation 406 through operation 420 may be optional. As another example, any of operation 506 through operation 518 may be optional.

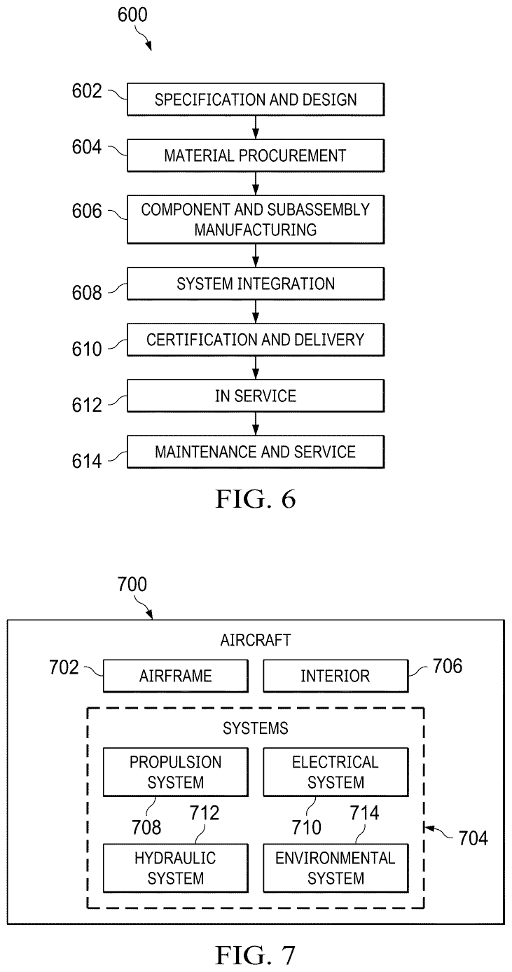

Illustrative embodiments of the present disclosure may be described in the context of aircraft manufacturing and service method 600 as shown in FIG. 6 and aircraft 700 as shown in FIG. 7. Turning first to FIG. 6, an illustration of an aircraft manufacturing and service method in a form of a block diagram is depicted in accordance with an illustrative embodiment. During pre-production, aircraft manufacturing and service method 600 may include specification and design 602 of aircraft 700 in FIG. 7 and material procurement 604.

During production, component and subassembly manufacturing 606 and system integration 608 of aircraft 700 takes place. Thereafter, aircraft 700 may go through certification and delivery 610 in order to be placed in service 612. While in service 612 by a customer, aircraft 700 is scheduled for routine maintenance and service 614, which may include modification, reconfiguration, refurbishment, or other maintenance and service.

Each of the processes of aircraft manufacturing and service method 600 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 7, an illustration of an aircraft in a form of a block diagram is depicted in which an illustrative embodiment may be implemented. In this example, aircraft 700 is produced by aircraft manufacturing and service method 600 of FIG. 6 and may include airframe 702 with plurality of systems 704 and interior 706. Examples of systems 704 include one or more of propulsion system 708, electrical system 710, hydraulic system 712, and environmental system 714. Any number of other systems may be included.

Apparatuses and methods embodied herein may be employed during at least one of the stages of aircraft manufacturing and service method 600. One or more illustrative embodiments may be manufactured or used during at least one of component and subassembly manufacturing 606, system integration 608, in service 612, or maintenance and service 614 of FIG. 6.

The illustrative examples control at least one of the humidity and the temperature within a forming area in which a pick and place forming operation is performed. The illustrative examples present an environmentally controlled automation cell within a humidity and temperature containing environment, such as a tent enclosure, within the manufacturing environment. The illustrative examples provide an outer containment to permit control of the pick and place and forming CMC operations. The outer containment can comprise physical boundaries such as at least one of walls, a tent, or drapes.

The illustrative examples utilize tracking, such as RFID monitors or other means, on the CMC material to track how long out of the freezer and track the environment it was exposed to while out of the freezer. The illustrative examples track and trace to monitor how long the material is out of the freezer (for example, using a RFID based tracking system), and adjust temperature and humidity to improve compaction and peeling of top and bottom protective film removal. RFID antenna gate monitors material as it is removed/placed in freezer. Time in/out of freezer for each material-kit is recorded in database.

The illustrative examples control at least one of the temperature or the humidity within the humidity and temperature containing forming area within the physical boundaries. In the illustrative examples, air or other gas is present within the physical boundaries.

CMC material is removed from a freezer and allowed to thaw to decrease matrix viscosity. In some illustrative examples, a working temperature is about 70 degrees Fahrenheit and about 65% humidity without modifying for exposure time. The illustrative examples recognize and take into account that it is difficult to form and work the CMC composite when it dries out and is not maintained at at least 60% humidity and the desired temperature range. Temperature and humidity are monitored by PLC, work is only performed when values are within a predetermined range.

By the illustrative examples monitoring and adjusting the humidity and temperature, reliability of automated film peeling and formability of material is improved. The illustrative examples provide a closed loop humidity and temperature control for at least one of improved usable-life, compactability, formability, or protective film removal within the physical boundaries of the forming area. The illustrative examples control at least one of the humidity or the temperature to control the viscosity of the matrix dependent on the amount of time the material is out of freezer. Compaction and peeling of protective films are improved by customizing the environment based on out time of material.

Water-based Ceramic Matrix Composite material is extremely sensitive to humidity, temperature, and time of exposure to the environment (out of freezer). The illustrative examples track and trace to monitor how long the material is out of the freezer. The illustrative examples can use an RFID based tracking system. The illustrative examples adjust at least one of temperature or humidity to improve compaction and peeling of top and bottom protective film removal. The illustrative examples provide better material performance and less wasted material.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A forming area for automated composite processing comprising:
physical boundaries defining and enclosing the forming area, the physical boundaries configured to substantially reduce transmission of a temperature and a humidity from the forming area;
a humidity sensor configured to detect the humidity in the forming area;
a thermostat configured to detect the temperature in the forming area; and
an environmental controller configured to perform at least one of activating or deactivating a heater or a humidifier based on data received from the humidity sensor and the thermostat.

2. The forming area of claim 1 further comprising:
a tracking system configured to document a time a composite material is exposed to the humidity and temperature in the forming area.

3. The forming area of claim 2, wherein the tracking system comprises an RFID antenna gate and an RFID tag.

4. The forming area of claim 1 further comprising:
a robotic end effector configured to pick and place a composite material in the forming area.

5. The forming area of claim 1 further comprising:
a freezer configured to store composite material in the forming area.

6. The forming area of claim 1 further comprising:
a heater; and
a humidifier.

7. The forming area of claim 1, wherein the physical boundaries comprise at least one of walls, drapes, or a tent.

8. The forming area of claim 1 further comprising an air conditioner.

9. A method of maintaining workability of a ceramic matrix composite material in a forming area comprising:
determining if a humidity within the forming area is in a desired range; and
in response to a determination that the humidity is not in the desired range, activating, by an environmental controller, at least one of a heater or a humidifier to maintain a desired humidity for forming the ceramic matrix composite material within the forming area.

10. The method of claim 9 further comprising:
determining if a temperature within the forming area is in a desired range; and
in response to a determination that the humidity is not in the desired range, activating, by an environmental controller, at least one of a heater or an air conditioner to maintain a desired temperature for forming the ceramic matrix composite material within the forming area.

11. The method of claim 9 further comprising:
determining the desired range of humidity based on a type of ceramic matrix composite material within the forming area.

12. The method of claim 11, wherein determining the desired range of humidity further comprises determining the desired range of humidity based on an exposure time of the ceramic matrix composite material to the humidity of the forming area.

13. The method of claim 11 further comprising:
detecting a tracker on the ceramic matrix composite material in the forming area; and
logging a time of detection of the tracker in response to detecting the tracker.

14. The method of claim 13 further comprising:
determining an exposure time of the ceramic matrix composite material based on the time of detection, wherein determining the desired range of humidity comprises determining the desired range of humidity based on the exposure time.

15. The method of claim 9 further comprising:
determining a desired range of humidity based on a current processing step for a ceramic matrix composite material in the forming area.

16. A method of maintaining workability of a ceramic matrix composite material in a forming area comprising:
determining an exposure time of a ceramic matrix composite material in the forming area; and
modifying a humidity in the forming area based on the exposure time of the ceramic matrix composite material.

17. The method of claim 16, wherein modifying the humidity in the forming area based on the exposure time of the ceramic matrix composite material comprises modifying the humidity in the forming area to a desired peel humidity for removing a protective film from the ceramic matrix composite material.

18. The method of claim 16, wherein modifying the humidity in the forming area based on the exposure time of the ceramic matrix composite material comprises modifying the humidity in the forming area to a desired workability for placing the ceramic matrix composite material onto a layup tool.

19. The method of claim 16, wherein modifying the humidity in the forming area comprises activating a humidifier by an environmental controller in communication with a humidity sensor and the humidifier.

20. The method of claim 16 further comprising:
modifying a temperature in the forming area based on the exposure time of the ceramic matrix composite material.

21. The method of claim 16 further comprising:
detecting a tracker on the ceramic matrix composite material in the forming area;
logging a time of detection of the tracker in response to detecting the tracker; and
determining an exposure time of the ceramic matrix composite material based on the time of detection, wherein determining the desired range of humidity comprises determining the desired range of humidity based on the time of detection.
